(19) United States
(12) Patent Application Publication
(10) Pub. No.: US 2025/0319922 A1
(43) Pub. Date: Oct. 16, 2025

(54) HYBRID STEER-BY-WIRE SYSTEM

(71) Applicant: Arnold NextG GmbH, Pfronstetten (DE)

(72) Inventors: Christoph HEISS, Jengen (DE); Oliver KAUFMANN, Beimerstetten (DE)

(73) Assignee: Arnold NextG GmbH, Pfronstetten (DE)

(21) Appl. No.: 19/172,759

(22) Filed: Apr. 8, 2025

(30) Foreign Application Priority Data
Apr. 15, 2024 (DE) 10 2024 110 539.9

(51) Int. Cl. B62D 5/00

(52) U.S. Cl. CPC B62D 5/003

(57) ABSTRACT

A steer-by-wire system for steering a motor vehicle includes two steering actuators for adjusting at least one steering angle of at least one wheel and/or at least one rigid axle of the motor vehicle. If one of the steering actuators fails, the motor vehicle can still be steered by the other of the steering actuators. The steer-by-wire system further includes a control device for processing steering signals and controlling the steering actuators on the basis of the steering signals. One of the steering actuators is from a first category and the other of the steering actuators is from a second category, which differs from the first category.

### CROSS REFERENCE TO RELATED APPLICATIONS

Applicant claims priority under 35 U.S.C. § 119 of German Application No. 10 2024 110 539.9 filed Apr. 15, 2024, the disclosure of which is incorporated by reference.

### BACKGROUND OF THE INVENTION

### 1. Field of the Invention

The invention relates to a steer-by-wire system, a control device for a steer-by-wire system and a method for adjusting at least one steering angle of at least one wheel of a motor vehicle by means of a steer-by-wire system.

### 2. Description of the Related Art

Conventional steering systems for motor vehicles have a direct mechanical coupling between the steering wheel and at least one wheel of the motor vehicle via the steering column and the steering gear. For some time now, so-called “power steering” systems have been used to assist the driver by reducing the steering effort required by means of a hydraulic or electric drive. In the event of a power steering failure, the driver can continue to steer the motor vehicle, albeit with significantly greater effort.

Steer-by-wire systems are steering systems for vehicles in which there is no direct mechanical coupling. Steering inputs are detected and forwarded to a control device in the form of (typically electrical) steering signals. On this basis, the control device in turn generates (typically electrical) control signals for a steering actuator, which causes a mechanical movement with which the steering angle is adjusted.

Steer-by-wire systems have a number of advantages over conventional steering systems. They allow the realization of dynamic steering systems, i.e., steering systems in which the relationship between the position of a steering input element—for example, a steering wheel—and the steering angle is not linear. Furthermore, the lack of a steering column reduces the risk of injury to the driver in the event of an accident. In addition, the flexibility in the arrangement of the steering input elements is increased. Steer-by-wire systems are particularly important for autonomous driving. Thus, the steering signals do not have to originate from a steering input element, or not exclusively, but can be partially or even completely (i.e., no steering input element is provided anymore—Level 5 according to SAE J3016) generated by a computing unit for autonomous control. However, if a steer-by-wire system fails, the vehicle can no longer be steered due to the lack of mechanical coupling. In order to ensure safe operation, steer-by-wire systems are therefore designed redundantly. Important components of a steer-by-wire system are present in duplicate or multiple copies, wherein if one component fails, another component takes over its role.

For example, a steer-by-wire system can comprise two steering actuators or actuator systems, so that if one steering actuator or part of its actuator system (for example, a hydraulic pump) fails, the vehicle remains steerable.

A steer-by-wire system for a motor vehicle is disclosed, for example, in WO 2017/198565 A1. The steer-by-wire system described therein has two steering actuators, which are designed for adjusting a steering angle of the particular steerable wheel. For this purpose, steering electronics are configured to detect whether one of the steering actuators has failed. In this case, the steering electronics switch to emergency mode, in which the motor vehicle remains controllable to a limited extent by the second (non-failed) steering actuator.

The steering actuators of the steer-by-wire system described in WO 2017/198565 A1 are electric servo motors.

However, the application areas of electric steering actuators are limited. In particular in larger vehicles, the required power is so high that suitable electric steering actuators are only very rarely used.

As an alternative, steer-by-wire systems are known from the prior art, in which hydraulic steering actuators are used instead of electric steering actuators.

However, hydraulic systems, despite their advantages, can be used only on a limited basis. They are larger and have higher latency and complexity. Furthermore, their efficiency is lower. In particular when using two independent hydraulic systems, the structural configurations are very extensive, since all components, including the hydraulic pump, for example, have to be present twice.

### SUMMARY OF THE INVENTION

In contrast, it is the object of the invention to provide an improved steer-by-wire system that extends the handling of the system.

This object is achieved by a steer-by-wire system for steering a motor vehicle, which has two or more steering actuators for adjusting at least one steering angle of at least one wheel and/or at least one rigid axle of the motor vehicle, wherein if one of the steering actuators fails, the motor vehicle can still be steered by another of the steering actuators. The system comprises at least one control device for processing steering signals and controlling the steering actuators on the basis of the steering signals, wherein at least one of the steering actuators is from a first category and at least one other of the steering actuators is from a second category, which differs from the first category.

The motor vehicle can, for example, be a passenger car, a truck, a tractor or a combine harvester. In particular, the motor vehicle can be an agricultural machine. The motor vehicle can, for example, have two, three, four or six wheels, a subset of which may be steerable. The motor vehicle can optionally also be designed so that all wheels are steerable.

Steering actuators are actuators for adjusting the steering angle of a wheel. An actuator is a technical element that generates a mechanical movement depending on a control signal.

For the purposes of this application, two actuators are of the same category if they use the same form of energy and are based on the same physical effect. For example, electrical, hydraulic and pneumatic actuators can be distinguished according to their category.

Actuators of different categories have different advantages and disadvantages. As a result of the combination of actuators of different categories, a complementary relationship exists between the steering actuators. In normal operation, i.e., as long as none of the steering actuators of different categories has failed, the advantages of the different categories can be combined and the disadvantages can be compensated. This does not require any additional effort, since two redundant systems are provided anyway due to the increased security.

Since the steer-by-wire system has two or more steering actuators for adjusting at least one steering angle, if one steering actuator (or a plurality of steering actuators, provided that at least one steering actuator continues to work correctly) is defective, the affected steering actuator can be deactivated and the steer-by-wire system continues to function with the correctly working steering actuator(s). Thus, the steer-by-wire system is “fail-operational.” In the event of a defect in an actuator system allocated to a steering actuator (for example, a hydraulic system for a hydraulic steering actuator, which in particular comprises a hydraulic pump and a hydraulic valve), this applies accordingly.

The steer-by-wire system can in particular comprise exactly one control device. The at least one control device is preferably an electronic control unit (ECU). The control device can in particular be programmable. It can comprise memory elements and a processor and/or a microcontroller. The control device can also optionally comprise further electronic components, for example a programmable logic module. The at least one control device is preferably designed to be fail-safe; in particular, it can have a redundant structure.

The steer-by-wire system can also comprise two or more control devices. In this case, the control devices are preferably designed to communicate with one another. In particular, the first category of steering actuators and the second category of steering actuators can each have a dedicated control device.

Preferably, the steer-by-wire system comprises at least one steering input element for detecting steering inputs and generating corresponding steering signals. Preferably, the at least one steering input element is exactly one steering input element. In this case, the steering input element is provided for operation by the driver. However, the steer-by-wire system can also have two steering input elements, for example, wherein the second steering input element can be operated by a driving instructor. The at least one steering input element can be, for example, at least one steering wheel, at least one mini steering wheel and/or at least one joystick. In the case of a plurality of steering input elements, these can also be of different types. For example, the steer-by-wire system can comprise a first steering input element in the form of a joystick and a second steering input element in the form of a steering wheel. The at least one steering input element is preferably connected to the at least one control device via redundant channels (digital and/or analog), whereby the steer-by-wire system continues to function even if one of the channels fails.

The steering signals do not have to originate from a steering input element, or do not have to originate exclusively from one, but can be generated partially or completely by a computing unit for autonomous control. The motor vehicle thus does not need to have a steering input element.

Preferably, the steer-by-wire system can comprise a force feedback unit that is connected to the at least one steering input element. Haptic feedback (force feedback) makes it possible for the driver to get a feel for the road conditions and the vehicle's response. Preferably, the force feedback includes both state parameters of the at least one steering actuator of the first category or of the actuator system allocated therewith and state parameters of the at least one steering actuator of the second category or of the actuator system allocated therewith. If the at least one steering actuator of the first category is a hydraulic steering actuator and the at least one steering actuator of the second category is an electric steering actuator, the force feedback can, for example, be generated both on the basis of the pressure of the hydraulic system and on the basis of the motor current. The combination of both sources can in particular provide a more direct steering feel.

The signal transmission between the at least one steering input element and the at least one control device and between the at least one control device and the steering actuators or an allocated actuator system is preferably carried out by means of standardized communication protocols. An example is the CAN bus. Alternatively, communication can also take place via modulated PWM signals (with feedback).

Preferably, the at least one control device can receive information from a plurality of input sources via interfaces (in particular of the type mentioned), in particular from radio remote controls and systems for teleoperated control and from environmental sensor kits.

The steer-by-wire system can in particular be designed so that it can be retrofitted, i.e., that a conventional steering system and/or a steer-by-wire system of the previously known type can be replaced by a steer-by-wire system according to the invention.

The at least one steering actuator of the first category and the at least one steering actuator of the second category preferably cause a change in the steering angle of the same wheel of the motor vehicle. The at least one steering actuator of the first category and the at least one steering actuator of the second category can in particular be active simultaneously, i.e., can simultaneously cause a change in the steering angle. However, it is also possible to use only one category at a given point in time. A combination of these approaches is also possible, i.e. a steering in which at some points in time the at least one steering actuator of the first category and the at least one steering actuator of the second category are active simultaneously, while at other points in time only the at least one steering actuator of the first category or only the at least one steering actuator of the second category is active.

If steering actuators of both categories are simultaneously active, they can be controlled so that they influence the steering angle to different degrees. Which category of steering actuators is active (or which is primarily controlled when both categories are active) can depend on a wide range of variables, in particular the driving situation, the steering signals, the state of the steering actuators, the magnitude of deviations in the control loop, and/or the type of motor vehicle.

Preferably, steering actuators of one of the categories are more rapid and/or more precise, while steering actuators of the other category provide a higher actuating force. In particular, a higher actuating force also makes possible a larger change in the steering angle in a given time. Due to the combined use of steering actuators of both categories, the steer-by-wire system has the advantages of both categories, i.e., it is not only rapid and/or precise, but also has a high actuating force for adjusting at least one steering angle.

The steer-by-wire system preferably comprises at least one sensor for measuring the steering angle, which is connected to the at least one control device, as a result of which a control loop is formed. Particularly preferably, there are a plurality of sensors for measuring the steering angle and/or at least one redundant sensor. As a result, the steering is made more precise, and the feedback to at least one control device is more reliable. The at least one sensor for measuring the steering angle is preferably integrated into the outer rotary joint or, in the case of an electric steering actuator, into it.

The pivot point of the wheel is referred to as the rotary joint. This rotary joint “connects” the steering knuckle to the axle.

Finally, the at least one control device is preferably configured so that the pressure in a hydraulic system of a hydraulic steering actuator of the steer-by-wire system is limited, wherein the limit decreases with increasing driving speed. The pressure should be reduced as the driving speed increases, since smaller steering angles must be implemented at higher speeds.

In one embodiment, at least one of the steering actuators is an electric steering actuator. Electric steering actuators, for example in the form of electric servo motors, are characterized by low latency and high precision.

In particular, when using an electric steering actuator, the latency of the steer-by-wire system in the steering response can be low. The high level of accuracy is in particular relevant for autonomous driving.

In one embodiment, at least one of the steering actuators is a hydraulic steering actuator. Hydraulic steering actuators are characterized by their high actuating force. High loads on the front axle (in agriculture, e.g., front loader activities) require high steering performance. This can be provided by the hydraulic system. In the event of a defect in the hydraulic steering actuator or the allocated hydraulic system, the hydraulic system can preferably be placed in a depressurized state (for example, by means of the at least one control device), which prevents the steering mechanism from becoming blocked.

In one embodiment, at least one of the steering actuators is a pneumatic steering actuator. Pneumatic steering actuators also have a relatively high actuating force. However, this is typically lower than with hydraulic steering actuators. Pneumatic steering actuators are shock-resistant, durable, maintenance-free and, unlike electric drives, consist of few components, making them less prone to malfunctions.

In one embodiment, at least one of the steering actuators is a hydraulic steering actuator and at least one other of the steering actuators is an electric steering actuator.

In one embodiment, at least one of the steering actuators is a pneumatic steering actuator and at least one other of the steering actuators is an electric steering actuator.

Alternatively, at least one of the steering actuators can be a hydraulic steering actuator and at least one other of the steering actuators can be a pneumatic steering actuator. In one embodiment, the steer-by-wire system additionally comprises at least one sensor for monitoring at least one of the steering actuators and/or an actuator system allocated therewith and providing a resulting sensor signal.

The at least one sensor can be used in particular to monitor the pressure and/or the temperature of a hydraulic system of a hydraulic steering actuator. Alternatively or additionally, the at least one sensor can serve to monitor power electronics of an electric steering actuator or of an electric steering actuator itself (for example, it is then a current or temperature sensor).

The sensor signal can then be used for deactivating the affected steering actuator or to preferably use another steering actuator by the at least one control device.

In one embodiment, the at least one control device is configured to control the steering actuators in such a way that the ratio of the proportion in which the at least one steering actuator of the first category acts on the steering angle to the proportion in which the at least one steering actuator of the second category acts on the steering angle depends on the driving situation.

The driving situation is determined in particular by the speed and/or the road surface (which can be determined by a navigation system and/or suitable sensors) and/or by whether the motor vehicle is negotiating a curve and its radius (which can also be determined, for example, by means of a navigation system and/or by means of sensors, for example by means of acceleration sensors).

Preferably, the first category is characterized by a higher actuating force, the second category by a lower latency and/or a higher precision. Preferably, the adjustment of the steering angle at low speeds is then carried out predominantly or completely by means of the at least one steering actuator of the first category, while at low speeds the steering is carried out predominantly or completely by means of the at least one steering actuator of the second category.

The speed limit typically depends on the type of motor vehicle. For agricultural machinery, this can preferably be 40 km/h or 50 km/h.

The first category can preferably consist of hydraulic actuators and the second category can preferably consist of electrical actuators. In particular, at low speeds the hydraulic power source is mainly used, since steering precision is less critical at slow speeds.

The hydraulics make higher steering forces and larger angle changes possible, in particular when maneuvering. At higher speeds, electric steering is preferred, since it typically responds more rapidly and can make more precise adaptations possible, which is an advantage at higher speeds. For safety reasons, large steering angles and rapid steering angle changes (as would be made possible with hydraulics) are typically not desired at high speed.

In one embodiment, the at least one control device is configured to control the steering actuators in such a way that the ratio of the proportion in which the at least one steering actuator of the first category acts on the steering angle to the proportion in which the at least one steering actuator of the second category acts on the steering angle depends on the steering signals.

This embodiment can be combined in particular with the aforementioned embodiment, i.e., the ratio of the proportion in which the at least one steering actuator of the first category acts on the steering angle to the proportion in which the at least one steering actuator of the second category acts on the steering angle can depend both on the driving situation and on the steering signals.

Preferably, the first category is characterized by a higher actuating force (for example, hydraulic steering actuators), the second category by a lower latency and/or a higher precision (for example, electric steering actuators). Preferably, in the case of steering signals that represent a large change in the steering angle, the adjustment of the steering angle is carried out predominantly or completely by the at least one steering actuator of the first category, whereas in the case of steering signals that represent a small change in the steering angle, the adjustment is carried out predominantly or completely by the at least one steering actuator of the second category.

For fine or minor steering maneuvers, electric power is particularly preferred, since it offers finer control and rapid responsiveness. When significant steering movements are required or when rapid adaptation is required, hydraulic power is preferably used.

In one embodiment, the steer-by-wire system additionally comprises at least one sensor for detecting at least one state parameter of the at least one steering actuator of the first category and/or of an actuator system allocated therewith, wherein the at least one control device is configured to control the steering actuators in such a way that the ratio of the proportion in which the at least one steering actuator of the first category acts on the steering angle to the proportion in which the at least one steering actuator of the second category acts on the steering angle depends on the detected value of the at least one state parameter.

The control device can be designed in particular for load-dependent control. In particular, steering actuators of the first category can have a higher actuating force than steering actuators of the second category. Preferably, at a low load, the adjustment of the steering angle is then carried out predominantly or completely by the at least one steering actuator of the second category, while at a high load, the adjustment of the steering angle is carried out predominantly or completely by the at least one steering actuator of the first category.

The state parameter can in particular be the motor current of an electric steering actuator. The motor current of the electric steering actuator (which responds first due to its low latency) is an indicator of the load.

In particular, a small amount of hydraulic support can be provided at low loads. At high loads (rapid and strong increases in motor current), high hydraulic support is preferably provided (since a high power requirement is assumed).

In one embodiment, the steer-by-wire system additionally comprises at least one sensor for detecting at least one actual value of the at least one steering angle, wherein the at least one control device is configured so that the ratio of the proportion in which the at least one steering actuator of the first category acts on the steering angle to the proportion in which the at least one steering actuator of the second category acts on the steering angle depends on a deviation of the actual value of the at least one steering angle from a corresponding target value.

In particular, steering actuators of the first category can have a higher actuating force than steering actuators of the second category. In the case of strong or significant deviations of the actual value from the target value of the steering angle, the at least one steering actuator of the first category (for example, at least one hydraulic steering actuator) is preferably used partially, particularly preferably predominantly, very particularly preferably completely, in order to achieve a more rapid adaptation to the target value.

Preferably, the aforementioned embodiments can be combined. The ratio of the proportion in which the at least one steering actuator of the first category acts on the steering angle to the proportion in which the at least one steering actuator of the second category acts on the steering angle can thus depend on the driving situation and/or on the steering signals and/or on the detected value of the at least one state parameter and/or on a deviation of the actual value of the at least one steering angle from a corresponding target value.

A further aspect of the invention relates to a control device for a steer-by-wire system, which is configured to receive steering signals and, on the basis of these steering signals, to control at least one steering actuator of a first category and at least one steering actuator of a second category, wherein the second category differs from the first category.

Preferably, the control device can be designed as described above in connection with the steer-by-wire system.

A further aspect of the invention relates to a method for adjusting at least one steering angle of at least one wheel of a motor vehicle by means of a steer-by-wire system, which comprises the steps of: providing steering signals and controlling at least one steering actuator of a first category and at least one steering actuator of a second category on the basis of the steering signals, wherein the second category differs from the first category.

Preferably, the method can be designed as described above in connection with the steer-by-wire system.

Further advantages of the invention can be found in the description and the drawings. Likewise, the aforementioned and the additional features listed below can be used individually or in any desired combination. The embodiments shown and described are not to be understood as an exhaustive list, but, rather, have an exemplary character for the explanation of the invention.

The invention can also be implemented in connection with an articulated steering system. It requires that a two-axle or multi-axle vehicle consists of at least two parts connected by a joint. The wheel axles are rigidly mounted in the partial bodies. A change in direction occurs by horizontally pivoting the vehicle parts.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a schematic representation of a steer-by-wire system according to the invention;

FIG. 2 is an illustration of the control loop underlying the steer-by-wire system according to the invention; and

FIGS. 3A, 3B, 3C, 3D, 3E, 3F, 3G, 3H, 3I, 3J, 3K, 3L, 3M and 3N are detailed representations of the arrangement of the steering actuators of a steer-by-wire system according to the invention.

### DETAILED DESCRIPTION OF PREFERRED EMBODIMENTS

In the following description of the drawing, identical reference signs are used for identical or functionally identical components.

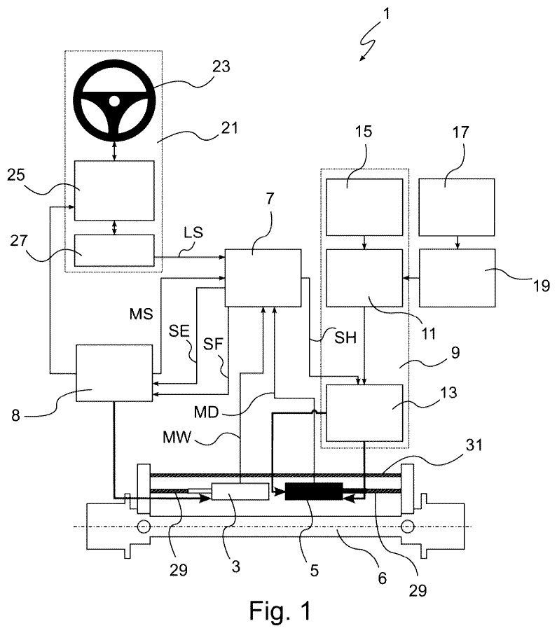

FIG. 1 shows a steer-by-wire system 1 for steering a motor vehicle.

The steer-by-wire system 1 comprises two steering actuators 3, 5 for adjusting at least one steering angle of at least one wheel of the motor vehicle. If one of the steering actuators 3, 5 fails, the motor vehicle can still be steered by the other of the steering actuators 3, 5. For ease of illustration, only one axle 6 of the motor vehicle is shown in the present case. The wheels themselves are not shown. The steer-by-wire system 1 can also comprise more than two steering actuators.

The steer-by-wire system 1 further comprises a control device 7 for processing steering signals LS and controlling the steering actuators 3, 5 on the basis of the steering signals LS.

One of the steering actuators 3, 5 is from a first category and the other of the steering actuators 3, 5 is from a second category, which differs from the first category. Specifically, but not necessarily, the steering actuators 3, 5 are an electric steering actuator 3 and a hydraulic steering actuator 5 by way of example.

The electric steering actuator 3 has an allocated actuator system comprising power electronics 8.

The hydraulic steering actuator 5 has an allocated actuator system in the form of a hydraulic system 9, which comprises a hydraulic pump 11, a hydraulic valve 13 and an oil tank 15. In particular, the hydraulic system 9 can be supplied with energy by the motor 17 of the motor vehicle via a transmission 19. The steer-by-wire system 1 shown also has a steering input element 21, although this is not a necessary component. In the example shown, the steering input element 21 comprises a steering wheel 23 and a force feedback unit 25 (which is controlled by the power electronics 8) and an encoder 27. Steering signals LS of the steering input element 21 are forwarded to the control device 7.

The control device 7 generates corresponding control signals SE, SH for controlling the steering actuators 3, 5, which are forwarded to the power electronics 8 or the hydraulic valve 13. For controlling the force feedback unit 25, the control device also generates force feedback control signals SF.

In the example shown, the steering actuators 3, 5 are arranged on opposite sides of the axle 6, i.e., each at one wheel of the axle 6, and have short coupling rods 29 for adjusting the steering angle. Furthermore, both sides are connected to a further coupling rod 31, so that both steering actuators 3, 5 in each case act on the steering angles of both wheels.

The steer-by-wire system 1 further comprises a sensor (not shown here) for monitoring the hydraulic steering actuator 5 by measuring the pressure MD. The corresponding sensor signal is forwarded to the control device 7.

Furthermore, the steer-by-wire system 1 comprises a steering angle sensor (not shown here) for detecting the actual value MW of at least one steering angle, which is forwarded to the control device 7.

Finally, the steer-by-wire system 1 comprises a sensor (not shown here) for detecting the value MS of a state parameter in the form of the motor current of the electric steering actuator 3, which is forwarded to the control device 7.

The control device 1 is configured, by way of example, to control the steering actuators 3, 5 in such a way that the ratio of the proportion in which the steering actuator 5 of the first category acts on the steering angle to the proportion in which the steering actuator 3 of the second category acts on the steering angle depends on the driving situation. Alternatively or additionally, the control device 1 can be configured to control the steering actuators 3, 5 in such a way that the ratio of the proportion in which the steering actuator 5 of the first category acts on the steering angle to the proportion in which the steering actuator 3 of the second category acts on the steering angle depends on the steering signals LS and/or the detected value of the state parameter MS and/or on the deviation of the actual value MW of the at least one steering angle from a corresponding target value.

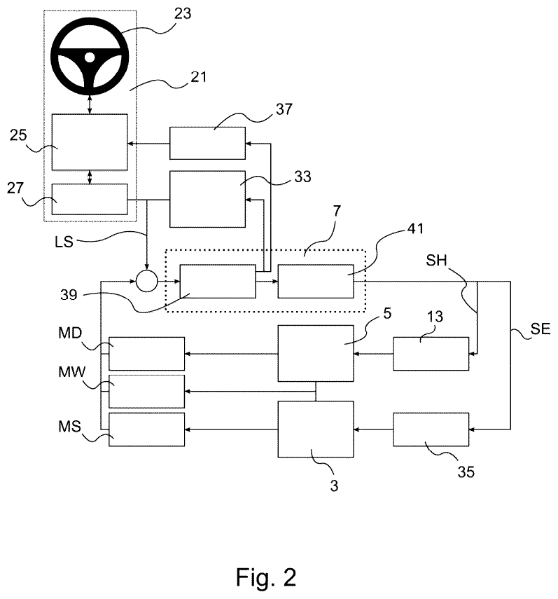

FIG. 2 illustrates the control loop underlying the steer-by-wire system 1 according to the invention.

In contrast to FIG. 1, the steer-by-wire system 1 has a computing unit 33 for autonomous control, so that the steering signals LS (here, steering angle specifications) also originate from this and not only from the steering input element 21.

The motor controller 35 of the electric steering actuator 3 and the motor controller 37 of the force feedback unit 25 are also shown.

The actual value of the regulated variable in the example shown is the measured pressure MD of the hydraulic steering actuator 5. In addition, the detected value MW of the steering angle and the detected value MS of the motor current of the electric steering actuator 3 are forwarded. The control signals SE, SH correspond to current specifications for the motor current or opening specifications for the hydraulic valve 13. The steering angle is regulated. The steering angle is adjusted by the two control variables of motor current and opening specification of the valve.

A force feedback controller 39, and a guide angle controller 41 as part of the control device 7, is also shown.

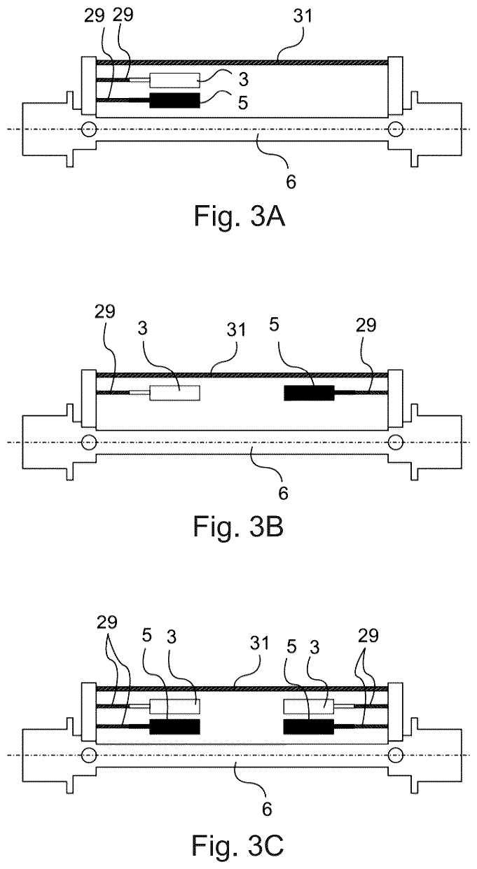

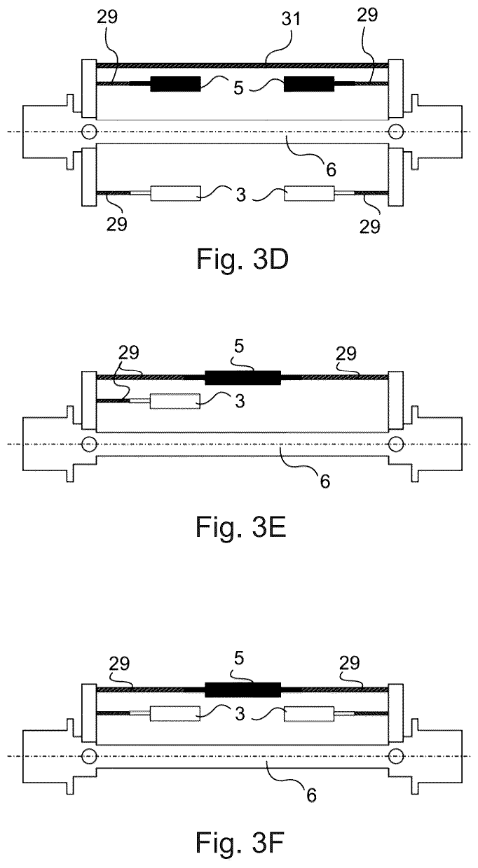

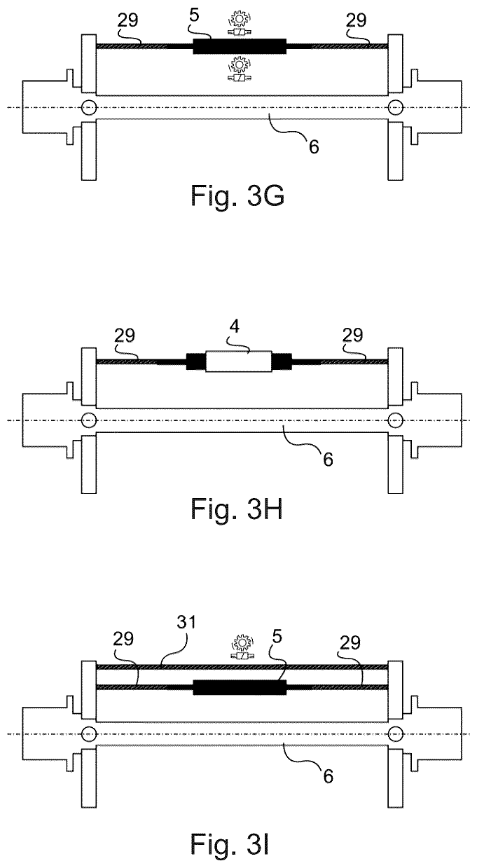

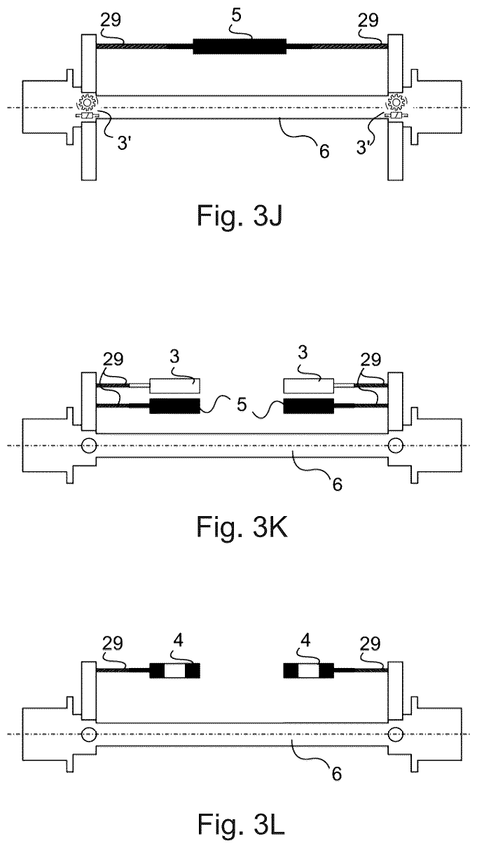

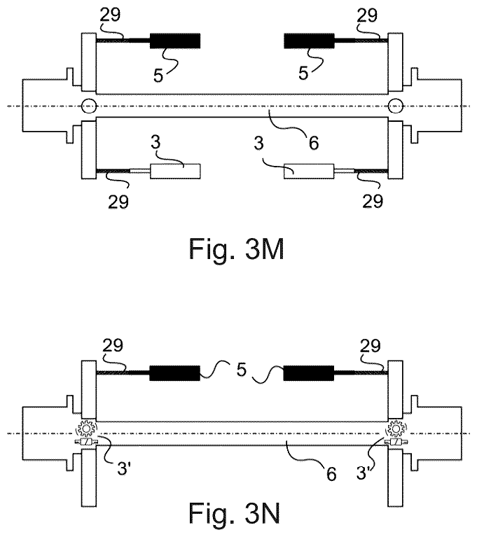

FIGS. 3A-3N are detailed representations illustrating variants of the mounting of the steering actuators of the steer-by-wire system according to the invention, the other components of which are not shown here. An axle 6 of the motor vehicle, at both ends of which wheels not shown here are arranged, is shown.

In FIG. 3A, the steer-by-wire system comprises an electric steering actuator 3 and a hydraulic steering actuator 5. In the example shown, the steering actuators 3, 5 are arranged on the same side of the axle 6 and have short coupling rods 29 for adjusting the steering angle. Furthermore, both sides are connected to a further coupling rod 31, so that both steering actuators 3, 5 in each case act on the steering angles of both wheels. The configuration is compact and makes efficient control possible.

In FIG. 3B, the steer-by-wire system comprises an electric steering actuator 3 and a hydraulic steering actuator 5. In FIG. 3A, the steer-by-wire system comprises an electric steering actuator 3 and a hydraulic steering actuator 5. In the example shown, the steering actuators 3, 5 are arranged on the same side of the axle 6 and have short coupling rods 29 for adjusting the steering angle. Furthermore, both sides are connected to a further coupling rod 31, so that both steering actuators 3, 5 in each case act on the steering angles of both wheels.

In FIG. 3C, the steer-by-wire system comprises two electric steering actuators 3 and two hydraulic steering actuators 5. On each side of the axle 6, an electric steering actuator 3 and a hydraulic steering actuator are arranged, which have short coupling rods 29 for adjusting the steering angle. Furthermore, both sides are connected to a further coupling rod 31, so that each pair of steering actuators 3, 5 acts on the steering angles of both wheels. The redundancy of the system is increased in this configuration.

In FIG. 3D, the steer-by-wire system comprises two electric steering actuators 3 and two hydraulic steering actuators 5. On each side of the axle 6, an electric steering actuator 3 and a hydraulic steering actuator are arranged, which have short coupling rods 29 for adjusting the steering angle. Furthermore, both sides are connected to a further coupling rod 31, so that each pair of steering actuators 3, 5 acts on the steering angles of both wheels. Unlike in FIG. 3C, the arrangement is mirror-symmetrical with respect to axle 6, exchanging the category.

For utilizing the installation space, the components of the invention can also be arranged opposite one another.

In FIG. 3E, the steer-by-wire system comprises an electric steering actuator 3 and a hydraulic steering actuator 5. In the example shown, the electric steering actuator 3 is arranged on one side of the axle 6 and has a short coupling rod 29 for adjusting the steering angle. The hydraulic steering actuator 5 is connected to both sides via coupling rods 29.

The arrangement in FIG. 3F corresponds to the arrangement in FIG. 3E, wherein in addition a further electric steering actuator 3 is provided, which is arranged on the opposite side.

In FIG. 3G, the steer-by-wire system comprises a hydraulic steering actuator 5, which is connected to both sides via coupling rods 29. The hydraulic steering actuator 5 additionally has a worm gear, which is driven by a further actuator, and/or an integrated spindle drive.

In FIG. 3H, the steer-by-wire system comprises a hybrid actuator 4 in the form of a hydraulic cylinder with an integrated electric motor. A hybrid actuator, such as the one shown here, thus comprises two actuators of different categories. For adjusting the steering angle, the hybrid actuator 4 has a short coupling rod 29 on each side.

In FIG. 3I, the steer-by-wire system comprises a hydraulic steering actuator 5, which is connected to both sides via coupling rods 29. Furthermore, an electric motor can be mechanically attached to a further coupling rod 31 as a further steering actuator in different ways. This configuration allows flexible adaptation of the electric drive to the specific needs of the steering system, including integration with rack and pinion or recirculating ball couplings for the precise transmission of steering movements.

In FIG. 3J, the steer-by-wire system comprises a hydraulic steering actuator 5, which is connected to both sides via coupling rods 29. An electric motor 3′ is connected as an actuator in the steering knuckle or via a gear and turntable. This configuration makes possible the precise and direct control of the wheel position, which improves the steering precision and responsiveness of the motor vehicle. In FIGS. 3K-3N, the steer-by-wire system is designed as an individual wheel steering system.

In FIG. 3K, the steer-by-wire system comprises two electric steering actuators 3 and two hydraulic steering actuators 5. An electric steering actuator and a hydraulic steering actuator are arranged on each side of axle 6.

In FIG. 3L, the steer-by-wire system comprises two hybrid actuators 4, wherein one of the hybrid actuators 4 is arranged on each side.

FIG. 3M shows a variant of the arrangement for the individual wheel steering system shown in FIG. 3K.

In FIG. 3N, the steer-by-wire system has two hydraulic steering actuators 5, of which one steering actuator 5 is arranged on each side. Two further drive units 3′ are also arranged in the steering knuckles.

In FIGS. 3A-3N, instead of the hydraulic steering actuators and the electric steering actuators, the steering actuators can also generally be steering actuators from a first category or steering actuators from a second category.

Although only a few embodiments of the present invention have been shown and described, it is to be understood that many changes and modifications may be made thereunto without departing from the spirit and scope of the invention.

What is claimed is:

1. A steer-by-wire system for steering a motor vehicle, comprising two or more steering actuators configured for adjusting at least one steering angle of at least one wheel and/or at least one rigid axle of the motor vehicle, wherein the system is configured such that if one of the steering actuators fails, the motor vehicle can still be steered by another of the steering actuators, and
at least one control device configured for processing steering signals and controlling the steering actuators on the basis of the steering signals, wherein
at least one of the steering actuators is from a first category and at least one other of the steering actuators is from a second category, which differs from the first category.

2. The steer-by-wire system according to claim 1, wherein at least one of the steering actuators is an electric steering actuator.

3. The steer-by-wire system according to claim 1, wherein at least one of the steering actuators is a hydraulic steering actuator.

4. The steer-by-wire system according to claim 1, wherein at least one of the steering actuators is a pneumatic steering actuator.

5. The steer-by-wire system according to claim 1, wherein at least one of the steering actuators is a hydraulic steering actuator and at least one other of the steering actuators is an electric steering actuator.

6. The steer-by-wire system according to claim 1, wherein at least one of the steering actuators is a pneumatic steering actuator and at least one other of the steering actuators is an electric steering actuator.

7. The steer-by-wire system according to claim 1, further comprising at least one sensor configured for monitoring at least one of the steering actuators and/or an actuator system allocated therewith and providing a resulting sensor signal.

8. The steer-by-wire system according to claim 1, wherein the at least one control device is configured to control the steering actuators in such a way that a ratio of a proportion in which the at least one steering actuator of the first category acts on the steering angle to a proportion in which the at least one steering actuator of the second category acts on the steering angle depends on a driving situation.

9. The steer-by-wire system according to claim 1, wherein the at least one control device is configured to control the steering actuators in such a way that a ratio of a proportion in which the at least one steering actuator of the first category acts on the steering angle to a proportion in which the at least one steering actuator of the second category acts on the steering angle depends on the steering signals.

10. The steer-by-wire system according to claim 1, further comprising at least one sensor configured for detecting at least one state parameter of the at least one steering actuator of the first category and/or of an actuator system allocated therewith, wherein the at least one control device is configured to control the steering actuators in such a way that a ratio of a proportion in which the at least one steering actuator of the first category acts on the steering angle to a proportion in which the at least one steering actuator of the second category acts on the steering angle depends on a detected value of the at least one state parameter.

11. The steer-by-wire system according to claim 1, further comprising at least one sensor configured for detecting at least one actual value of the at least one steering angle, wherein the at least one control device is configured so that a ratio of a proportion in which the at least one steering actuator of the first category acts on the steering angle to a proportion in which the at least one steering actuator of the second category acts on the steering angle depends on a deviation of an actual value of the at least one steering angle from a corresponding target value.

12. A control device for a steer-by-wire system, which is configured to receive steering signals and, on the basis of these steering signals, to control at least one steering actuator of a first category and at least one steering actuator of a second category, wherein the second category differs from the first category.

13. A method for adjusting at least one steering angle of at least one wheel of a motor vehicle by means of a steer-by-wire system, comprising the steps of:
providing steering signals,
controlling at least one steering actuator of a first category and at least one steering actuator of a second category on the basis of the steering signals, wherein the second category differs from the first category.
